(19) United States
(12) Patent Application Publication
(10) Pub. No.: US 2026/0036216 A1
(43) Pub. Date: Feb. 5, 2026

(54) Pressure Relief Assembly

(71) Applicant: Donaldson Company, Inc., Bloomington, MN (US)

(72) Inventors: Matthew J. Goode, Blaine, MN (US); Matthew P. Brownson, Stillwater, MN (US); Daniel J. Dotzler, Webster, MN (US); Scott A. Betcher, Lakeville, MN (US)

(21) Appl. No.: 19/288,146

(22) Filed: Aug. 1, 2025

Related U.S. Application Data
(60) Provisional application No. 63/678,887, filed on Aug. 2, 2024.
(60) Provisional application No. 63/769,306, filed on Mar. 10, 2025.

(51) Int. Cl. F16K 17/164

(52) U.S. Cl. CPC F16K 17/164

(57) ABSTRACT

A breather assembly has an assembly body defining an airflow pathway between an assembly opening and an outside environment through environmental openings. A valve stem is coupled to the assembly body and extends axially from a proximal end to a distal end. The airflow pathway has a valve pathway laterally surrounding the valve stem. The valve body is disposed across the valve pathway having an inner perimeter coupled to the valve stem and an outer perimeter defining a sealing lip forming a releasable seal with the assembly body. The sealing lip is translatable between a closed position towards the proximal end of the valve stem and a fully open position towards the distal end of the valve stem. Greater than 96% of a flow area of the environmental openings is positioned beyond the inner perimeter of the valve body in the axial direction.

This application claims the benefit of U.S. Provisional Application No. 63/769,306 filed 10 Mar. 2025 and U.S. Provisional Application No. 63/678,887 filed 2 Aug. 2024, the disclosures of which are incorporated by reference in their entireties.

### TECHNOLOGICAL FIELD

The present disclosure is generally related to a pressure relief assembly. More particularly, the present disclosure is related to a breather assembly.

### SUMMARY

Some embodiments of the technology disclosed herein relate to a breather assembly. The breather assembly has a coupling structure, an assembly body, a valve stem, and a valve body. The coupling structure is configured to be coupled to a housing. The assembly body defining an assembly opening, environmental openings, and an airflow pathway between the assembly opening and an outside environment through the environmental openings. The airflow pathway has a valve pathway. The valve stem is coupled to the assembly body. The valve stem extends axially from a proximal end to a distal end. The valve pathway laterally surrounds the valve stem. The valve body is disposed across the valve pathway having an inner perimeter defining a valve opening and an outer perimeter defining a sealing lip forming a releasable seal with the assembly body. The inner perimeter is coupled to the valve stem. The sealing lip is translatable between a closed position towards the proximal end of the valve stem and a fully open position away from the proximal end and beyond the distal end of the valve stem.

In some such embodiments, the inner perimeter is coupled to the valve stem towards the distal end of the valve stem. Additionally or alternatively, the assembly body has a sidewall laterally surrounding the valve body. Additionally or alternatively, the sidewall is within 4 mm of the valve sealing lip. Additionally or alternatively, the breather assembly further including an end wall extending laterally across the airflow pathway. Additionally or alternatively, the valve stem has a lateral extension on the distal end that extends laterally outward from the valve stem. Additionally or alternatively, the valve body is configured to abut the outer perimeter of the lateral extension in the fully open position. Additionally or alternatively, the valve body is compressibly received between the assembly body and the lateral extension.

Additionally or alternatively, the breather assembly has a vent pathway and a passive airflow vent. The vent pathway is functionally parallel with the valve pathway along the airflow pathway. The lateral extension defines a vent mounting surface and the vent pathway extends axially through the vent mounting surface and the valve stem. The passive airflow vent having a perimetric region coupled to the vent mounting surface across the vent pathway, and an unbonded region central to the perimetric region. Additionally or alternatively, the lateral extension defines a recessed surface centrally to the vent mounting surface to define a gap between the unbonded region of the passive airflow vent and the lateral extension. Additionally or alternatively, the unbonded region of the passive airflow vent has a surface area that is at least 5 times greater than a lateral area of the vent pathway through the valve stem. Additionally or alternatively, the assembly body has a base portion and a cover. The cover extends laterally across the airflow pathway. Additionally or alternatively, the valve stem is compressibly received by the valve body. Additionally or alternatively, the valve stem is integral with the assembly body.

Some embodiments of the technology disclosed herein relate to a breather assembly having a coupling structure, an assembly body, a vent stand, a passive airflow vent, and a valve body. The coupling structure is configured to be coupled to a housing. The assembly body defining an assembly opening, environmental openings, and an airflow pathway between the assembly opening and an outside environment through the environmental openings. The airflow pathway has a vent pathway and a valve pathway functionally parallel with the vent pathway along the airflow pathway. The vent stand is coupled to the assembly body. The vent stand has a lateral extension defining a vent mounting surface and a valve stem extending axially outward from the lateral extension. The vent pathway extends axially through the vent mounting surface and the valve stem, the vent mounting surface extends laterally outward from the valve stem, and the valve pathway surrounds the vent stand. The passive airflow vent having a perimetric region coupled to the vent mounting surface across the vent pathway, and an unbonded region central to the perimetric region. The valve body is disposed across the valve pathway having inner perimeter defining a valve opening and an outer perimeter defining a sealing lip. The valve stem is disposed in the valve opening. The sealing lip is laterally outwards from the vent mounting surface.

In some such embodiments, the lateral extension defines a recessed surface centrally to the vent mounting surface to define a gap between the unbonded region of the passive airflow vent and the lateral extension. Additionally or alternatively, the unbonded region of the passive airflow vent has a surface area that is at least 5 times greater than a lateral area of the vent pathway through the valve stem. Additionally or alternatively, the assembly body has a base portion and a cover. The cover extends laterally across the airflow pathway. Additionally or alternatively, the valve body is compressibly received between the assembly body and the lateral extension. Additionally or alternatively, the valve stem is compressibly received by the valve body. Additionally or alternatively, the valve stem is integral with the assembly body.

Additionally or alternatively, the assembly body comprises a sidewall laterally surrounding the valve body. Additionally or alternatively, there is a lateral gap between the sidewall and the valve sealing lip of 3 mm or more. Additionally or alternatively, there is a lateral gap between the sidewall and the valve sealing lip of less than 6 mm. Additionally or alternatively, there is a lateral gap between the sidewall and the valve sealing lip of less than 4 mm. Additionally or alternatively, the sidewall has an axial length that is greater than an axial length of the valve body. Additionally or alternatively, the sidewall has an axial length that is greater than an axial length from a valve sealing surface of the valve body to the distal end of the valve stem. Additionally or alternatively, the environmental openings define a flow area, and greater than 96% of the flow area of the environmental openings is positioned in the axial direction towards the first end of the assembly body, beyond the inner perimeter of the valve body. Additionally or alternatively, the valve body has a fully open position where the sealing lip defines a distal end of the valve body.

Some embodiments of the present technology relate to a breather assembly having a coupling structure configured to be coupled to a housing. An assembly body has a first end and a second end and defines an assembly opening. The breather assembly has environmental openings and an airflow pathway between the assembly opening and an outside environment through the environmental openings. The airflow pathway includes a valve pathway. A valve stem is coupled to the assembly body which extends axially from a proximal end to a distal end, and the valve pathway laterally surrounds the valve stem. A valve body is disposed across the valve pathway. The valve body has an inner perimeter defining a valve opening and an outer perimeter defining a sealing lip forming a releasable seal with the assembly body. The inner perimeter is coupled to the valve stem. The sealing lip is translatable between (1) a closed position towards the proximal end of the valve stem where the sealing lip defines a proximal end of the valve body and (2) a fully open position towards the distal end of the valve stem. The environmental openings define a flow area, and greater than 96% of the flow area of the environmental openings is positioned in the axial direction towards the first end of the assembly body, beyond the inner perimeter of the valve body.

In some such embodiments, in a fully open position, the sealing lip defines a distal end of the valve body. Additionally or alternatively, the inner perimeter is coupled to the valve stem towards the distal end of the valve stem. Additionally or alternatively, the assembly body has a sidewall laterally surrounding the valve body. Additionally or alternatively, there is a lateral gap between the sidewall and the valve sealing lip of 1 mm or more. Additionally or alternatively, there is a lateral gap between the sidewall and the valve sealing lip of 3 mm or more. Additionally or alternatively, there is a lateral gap between the sidewall and the valve sealing lip of less than 6 mm. Additionally or alternatively, there is a lateral gap between the sidewall and the valve sealing lip of less than 4 mm.

Additionally or alternatively, the sidewall has an axial length that is greater than an axial length of the valve body. Additionally or alternatively, the sidewall has an axial length that is greater than an axial length from a valve sealing surface of the valve body to the distal end of the valve stem. Additionally or alternatively, including an end wall extending laterally across the airflow pathway. Additionally or alternatively, the valve stem includes a lateral extension on the distal end that extends laterally outward from the valve stem. Additionally or alternatively, the valve body is configured to abut the outer perimeter of the lateral extension in the fully open position. Additionally or alternatively, the valve body is compressibly received between the assembly body and the lateral extension. Additionally or alternatively, the breather assembly has a vent pathway that is functionally parallel with the valve pathway along the airflow pathway, the lateral extension defines a vent mounting surface, and the vent pathway extends axially through the vent mounting surface and the valve stem. A passive airflow vent has a perimetric region coupled to the vent mounting surface across the vent pathway, and an unbonded region central to the perimetric region.

Additionally or alternatively, the lateral extension defines a recessed surface centrally to the vent mounting surface to define a gap between the unbonded region of the passive airflow vent and the lateral extension. Additionally or alternatively, the unbonded region of the passive airflow vent has a surface area that is at least 5 times greater than a lateral area of the vent pathway through the valve stem. Additionally or alternatively, the assembly body includes a base portion and a cover, where the cover extends laterally across the airflow pathway. Additionally or alternatively, the valve stem is compressibly received by the valve body. Additionally or alternatively, the valve stem is integral with the assembly body. Additionally or alternatively, in the fully open position the sealing lip is beyond the distal end of the valve stem.

The above summary is not intended to describe each embodiment or every implementation. Rather, a more complete understanding of illustrative embodiments will become apparent and appreciated by reference to the following Detailed Description and claims in view of the accompanying figures of the drawing.

### BRIEF DESCRIPTION OF THE DRAWINGS

The present technology may be more completely understood and appreciated in consideration of the following detailed description of various embodiments in connection with the accompanying drawings.

FIG. 1 depicts a perspective view of a portion of an example system consistent with the present technology.

FIG. 2 is a cross-sectional view an example assembly consistent with FIG. 1 when the valve sealing lip is in a closed position.

FIG. 3 is a cross-sectional view an example assembly consistent with FIG. 1 when the valve sealing lip is in a fully open position.

FIG. 4 is a cross-sectional view of another example system consistent with FIG. 1.

FIG. 5 is cross-sectional view of another example assembly consistent with the present technology.

FIG. 6 is an exploded view of another example assembly consistent with the present technology.

FIG. 7 is a cross-sectional view of the example assembly when the valve sealing lip is in a fully open position.

FIG. 8 reflects test results comparing average flip pressure of breather assemblies having varying gaps between the sidewall and the sealing lip.

FIG. 9 reflects test results reflecting the extension of the valve sealing lip upon fully opening for example breather assemblies having various sidewall heights.

FIG. 10 reflects test results reflecting the extension of the valve sealing lip upon fully opening for example breather assemblies having various sidewall heights.

FIG. 11 reflects test results reflecting the extension of the valve sealing lip upon fully opening for example breather assemblies having various sidewall heights.

FIG. 12 reflects test results reflecting the extension of the valve sealing lip upon fully opening for example breather assemblies having various sidewall heights.

FIG. 13 reflects test results comparing average flip pressure of breather assemblies having varying sidewall heights.

FIG. 14 reflected test results comparing the average flip pressure of breather assemblies having varying gaps between the sidewall and the sealing lip.

FIG. 15 is an example connector structure.

FIG. 16 is a detail facing view of a portion of the example connector structure of FIG. 15.

FIG. 17 is a detail facing view of another portion of the example connector structure of FIG. 15.

The figures are rendered primarily for clarity and, as a result, are not necessarily drawn to scale. Moreover, various structures/components, including but not limited to fasteners, electrical components (wiring, cables, etc.), and the like, may be shown diagrammatically or removed from some or all of the views to better illustrate aspects of the depicted embodiments, or where inclusion of such structure/components is not necessary to an understanding of the various exemplary embodiments described herein. The lack of illustration/description of such structure/components in a particular figure is, however, not to be interpreted as limiting the scope of the various embodiments in any way.

### DETAILED DESCRIPTION

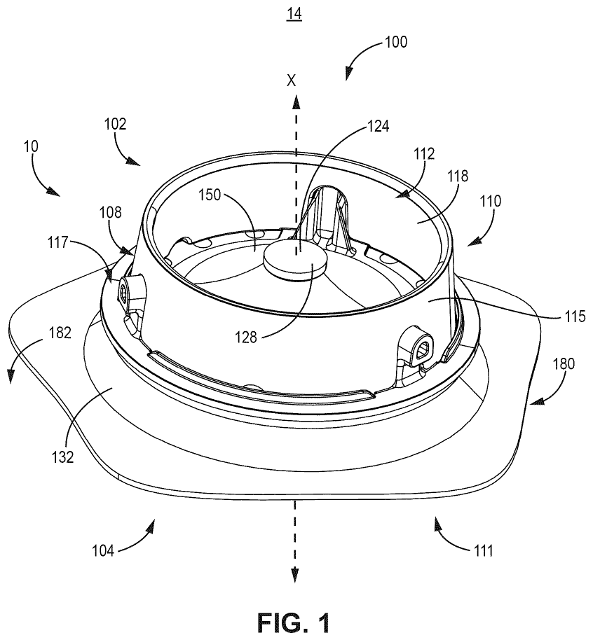

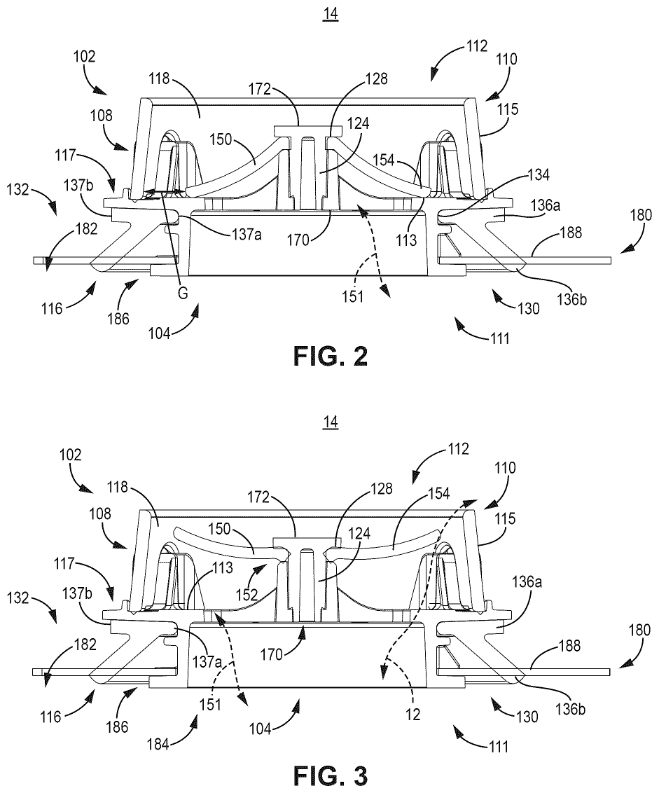

FIG. 1 depicts a perspective view of a portion of an example system 10 having a housing 180 and a breather assembly 100. FIGS. 2-3 depict cross-sectional views of the breather assembly 100 in different operational modes. The housing 180 can be consistent with a variety of different types of housings known in the art. In some specific implementations, the housing is a battery housing. The housing 180 generally defines an interior 182.

The breather assembly 100 is generally configured to be coupled to the housing 180. The breather assembly 100 has a first end 102 and a second end 104. The breather assembly 100 is generally configured to facilitate airflow between the housing 180 and an outside environment 14 when it is coupled to the housing. The breather assembly 100 has an assembly body 110. The breather assembly 100 has a coupling structure 116 configured to be coupled to the housing 180. The breather assembly 100 has a valve stem 124 coupled to the assembly body 110. The assembly body 110 has a valve body 150 coupled to the valve stem 124. The housing 180 that the breather assembly 100 is configured to be coupled to generally defines a housing opening 184 that is configured to receive the breather assembly 100. The housing 180 defines a mating structure 186 around the housing opening 184. The mating structure 186 is generally configured to mate with the coupling structure 116. In various embodiments the mating structure 186 is configured to sealably engage a breather assembly 100.

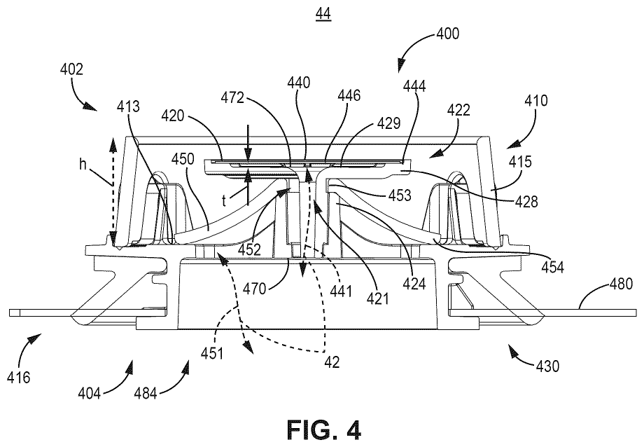

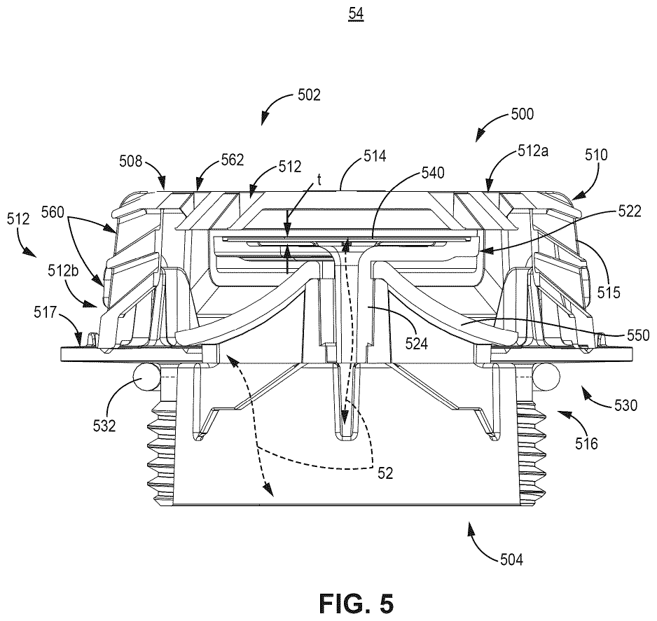

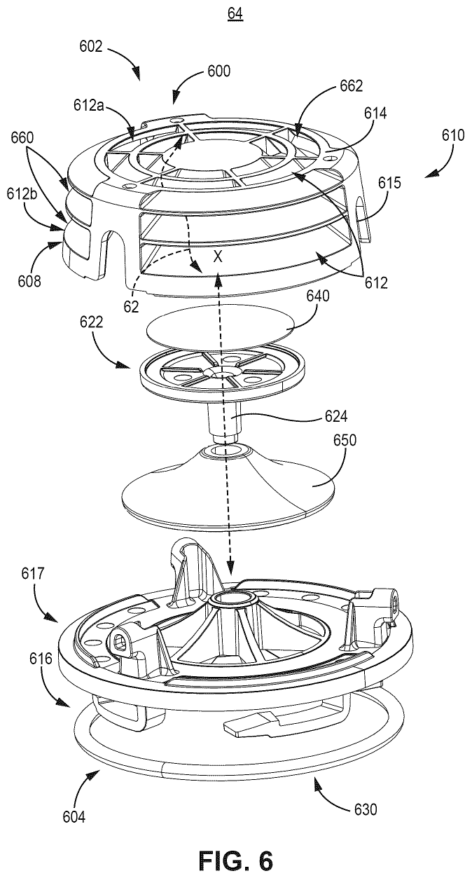

In various implementations the coupling structure 116 allows coupling of the breather assembly 100 to a housing 180 from the outside of the housing 180 without accessing the inside of the housing 180. In the current example and also in FIGS. 4 and 6, the coupling structure 116 includes a bayonet connector. In some such embodiments, the bayonet connector is defined by the assembly body 110. The mating structure 186 is a bayonet receptacle that is configured to be received by the bayonet connector. In some embodiments the coupling structure and the housing form a snap fit. In some embodiments, for example in FIG. 5, a coupling structure 516 is a screw thread. In some such embodiments, the mating structure is a mating thread that is configured to be coupled to the screw thread. In some embodiments the coupling structure is a contact surface that is configured to couple to a mating contact surface of the housing around the housing opening. In such examples, the coupling structure can be coupled to the housing through the use of fasteners, adhesives, welds, and the like.

As shown in FIGS. 1-3, the coupling structure 116 includes a sealing surface 130 that is configured to form a seal between the breather assembly 100 and the housing 180 around the housing opening 184. In the current example, the scaling surface 130 is defined, at least in part, by a sealing ring 132 that is configured to be compressed between the breather assembly 100 and the housing 180 around the housing opening. The sealing surface 130 is configured to create a seal, for example a negative pressure seal, between the assembly body 110 and the housing 180 when the breather assembly 100 is coupled to the housing 180. In embodiments consistent with FIGS. 1-4, the sealing surface 130 is defined around the assembly body 110. The scaling ring 132 can be an elastomeric material. In the current embodiments the scaling ring 132 is rubber or another gasketing or sealing material. In some embodiments, for example FIGS. 1-3, the sealing surface 130 includes a perimetric (e.g, circumferential) recess 134 that is configured to receive the scaling ring 132. In some other embodiments, for example in FIG. 5, the sealing surface 130 does not include an annular recess.

In the current example, the sealing ring 132 is a gasket. The scaling ring 132 is disposed around the assembly body 110 and is configured to create a seal between the assembly body 110 and the housing 180. The sealing ring 132 generally has a first seal end 136a, a second seal end 136b. The first seal end 136a has an inner perimeter 137a and an outer perimeter 137b laterally outward from the inner perimeter 137a. The inner perimeter 137a abuts a perimetric surface of the assembly body 110. The first seal end 136a abuts a lateral surface of the assembly body 110. The sealing ring 132 extends laterally and axially outward from the first seal end 136a to the second seal end 136b. More particularly, the sealing ring 132 extends laterally outward from the perimetric recess 134 of the assembly body 110.

The housing 180 defines a housing sealing surface 188 that receives the second seal end 136b. The housing sealing surface 188 is defined circumferentially around the central axis x of the breather assembly 100. The sealing ring 132 forms a seal between the assembly body 110 and the housing 180 along the housing scaling surface 188. For example, the sealing ring 132 is compressed between a base portion 117 of the assembly body 110 and the housing sealing surface 188 when the assembly body 110 is coupled to the housing 180. In some embodiments, the housing sealing surface 188 may be flat. In some other embodiments, the housing sealing surface 188 is a non-flat surface. The configuration of the sealing ring 132 may advantageously enable installation and retention of the breather assembly while providing scaling protection against ingress against a non-flat housing sealing surface. In various implementations the sealing ring 132 is configured to maintain sealing contact with the housing 180 beyond a first threshold pressure differential at which the valve body is displaced (discussed in more detail below).

As is particularly visible in FIG. 5, another example coupling structure 516 is depicted, includes a sealing surface 530 that is configured to form a seal between a breather assembly 500 and the housing around the housing opening. In FIG. 5, the scaling surface 530 is defined, at least in part, by a sealing ring 532 that is configured to be compressed between the breather assembly 500 and the housing, or around the housing opening. The sealing surface 530 is configured to create a seal between the breather assembly 500 and the housing, or when the breather assembly 500 is coupled to the housing. In embodiments consistent with FIG. 5, the sealing surface 530 is defined around the screw thread. In some embodiments, for example in FIGS. 1-4 and 6, the sealing surface 130, 430, 630 is defined around the bayonet connector.

Returning to FIGS. 1-3, the assembly body 110 has an assembly opening 111 and an environmental opening 112. The assembly opening 111 (visible in FIG. 2) is generally configured for direct fluid communication with an interior 182 of a housing 180, and the environmental opening 112 is generally configured for direct fluid communication with the outside environment 14. The assembly body 110 defines an airflow pathway 12 (visible in FIG. 3) between the assembly opening 111 and the outside environment through the environmental opening 112. When coupled to a housing 180, the assembly body 110 defines the airflow pathway 12 between the interior 182 of the housing 180 and the outside environment 14. In the current embodiments, the airflow pathway 12 is configured to allow selective gaseous communication between the enclosure and the outside environment 14. In some other embodiments, the airflow pathway 12 is configured to allow constant gaseous communication between the interior 182 and the outside environment 14. In some implementations, the interior 182 is configured to be isolated from the outside environment 14 except through the airflow pathway 12.

The airflow pathway 12 defined by the assembly body 110 has a valve pathway 151 that is configured to allow selective airflow communication between the interior 182 and the outside environment 14. The valve body 150 is disposed in the assembly body 110 and is configured to selectively obstruct the valve pathway 151. The valve body 150 is configured to selectively obstruct a valve pathway 151 between the assembly opening 111 and the environmental opening 112. The valve body 150 is generally configured to allow gases from inside the housing 180 to escape to the outside environment 14 when the environment inside the housing 180 undergoes a relative pressure spike. Upon a relatively high pressure event inside the housing 180 that reaches a first threshold pressure differential with the external environment, the valve body 150 is configured to open. In some embodiments the valve body 150 opens irreversibly. In some embodiments the valve body 150 opens reversibly, meaning that the valve body 150 returns to a closed position once the pressure inside the housing lowers to a second threshold pressure differential with the external environment. The valve configuration will be discussed in more detail below.

In the current example, the assembly body 110 has an assembly sidewall 115 extending in the axial direction. The assembly sidewall 115 is positioned towards the first end 102 of the breather assembly 102 in this example. The assembly sidewall 115 is positioned between the airflow pathway and the external environment and is around a central axis x. The assembly sidewall 115 laterally surrounds the airflow pathway. The assembly sidewall 115 defines at least a portion of the environmental opening. The assembly sidewall 115 extends in the axial direction between the first end 102 and the second end 104. The assembly body 110 has a sidewall 118 laterally surrounding the valve body 150. The sidewall 118 surrounds the valve body 150 around the central axis x. The sidewall 118 extends in the axial direction between the first end 102 and the second end 104.

In the current example, the assembly body 110 has the base portion 117 and a cover 108 that is coupled to, or is integral with, the base portion 117. The cover 108 generally extends in the axial direction. The cover 108 extends laterally around the airflow pathway 12. In the current example, the cover 108 defines at least a portion of the environmental opening 112. The cover 108 includes the assembly sidewall 115. In the current example, the cover 108 and the base portion 117 together define the assembly sidewall 115. In some other embodiments, for example in FIGS. 5 and 6, the cover includes the assembly sidewall and an end face. The base portion 117 extends laterally across the assembly sidewall 115 towards the second end 104 of the breather assembly 100. In some embodiments, the cover is not a separate component from the base portion 117 such that the base portion 117 defines the sidewall 118. In such an example the cover and the base portion 117 can be considered an integral, unitary component.

In some embodiments, the breather assembly 100 has the valve stem 124 extending axially outward from a distal end 172. The valve pathway 151 laterally surrounds the valve stem 124. In the current example (FIGS. 1-3), the valve stem 124 has a lateral extension 128 extending laterally outward from a valve opening 152. The lateral extension 128 is towards the distal end 172. In various embodiments, the valve body 150 is configured to abut the lateral extension 128 in the fully open position, an example of which is depicted in FIG. 3.

The valve stem 124 is a separate component that is coupled to the base portion 117 of the assembly body 110. In some other embodiments, the valve stem 124 integral with the assembly body 110 to form a single, unitary component. In some embodiments, the valve stem 124 is fused to the assembly body 110, such as through a welding operation. Examples of welding methods include heat welding and ultrasonic welding, although other types of welding are certainly possible. In some embodiments the valve stem 124 and the valve body 150 form an interference fit, such as where the valve body 150 defines the valve opening 152 that receives the valve stem 124, the valve body 150 can engage the valve stem 124 around the valve opening 152. In some examples, the valve stem 124 is compressibly received by the valve body 150.

In various embodiments, the valve body 150 is coupled to the valve stem 124. The valve body 150 is compressibly received between the assembly body 110 and the lateral extension 128. The valve body 150 extends radially outward from the valve stem 124. In the current example, the inner perimeter is coupled to the valve stem 124 such that the valve stem 124 is disposed in the valve opening 152. The diameter of the valve stem 124 could be any suitable value. For example, the diameter of the valve stem 124 may be 0.5 mm or greater, 1 mm or greater, 1.5 mm or greater, 2 mm or greater, 5 mm or greater, 10 mm or greater, 15 mm or greater, 20 mm or greater, 25 mm or greater, 30 mm or greater, 35 mm or greater, or 40 mm or greater. The diameter of the valve stem 124 may be 50 mm or less, 45 mm or less, 40 mm or less, 35 mm or less, 30 mm or less, 25 mm or less, 20 mm or less, 10 mm or less, 5 mm or less, 2 mm or less, or 1 mm or less. Preferably, the diameter of the valve stem 124 is between 1.5 mm to 3 mm.

The valve body 150 extends radially outward from the valve opening 152 to a sealing lip 154 in removable contact with a valve sealing surface 113 defined by the assembly body 110. In various embodiments, the valve sealing surface 113 is positioned radially outward from the valve stem 124.

The valve body 150 has an inner perimeter defining the valve opening 152, and the valve body 150 extends from the inner perimeter to the sealing lip 154 defined by an outer perimeter. The sealing lip 154 is laterally outwards from the distal end 172 of the valve stem. The assembly body 110 defines the valve sealing surface 113 that receives the sealing lip 154. The valve sealing surface 113 is defined circumferentially around the central axis x of the breather assembly 100. The scaling lip 154 forms a releasable seal with the assembly body 110 along the valve sealing surface 113. For example, upon a relatively high-pressure event within the housing 180, the sealing lip 154 is displaced from the valve sealing surface 113 to release pressure along the valve pathway 151. The inner perimeter of the assembly body 110 is coupled to the valve stem 124. In some embodiments, the inner perimeter of the assembly body 110 is coupled to the valve stem 124 towards the distal end 172.

The sealing lip 154 is translatable between a closed position towards a proximal end 170 of the valve stem 124 and a fully open position away from the proximal end 170 and towards the distal end 172 of the valve stem 124. The sidewall 118 is generally spaced from the valve sealing lip 115 to define a gap G that prevents interference from the sidewall 118 on the valve body 150 from the closed position to the fully open position. The gap G can be less than 10 mm, is less than 8 mm, less than 7 mm, or is less than 5 mm. In some embodiments, the gap G is less than or equal to 6 mm, 5 mm, 4 mm, or 3 mm.

Without wishing to be bound by theory, it has been discovered that use of a sidewall and advantageous spacing between the sidewall and the sealing lip enables the sealing lip 154 to translate from the closed position (FIG. 2) to the fully open position (FIG. 3) with a relatively lower pressure differential between the interior 182 and the outside environment 14 compared to a breather assembly lacking a sidewall. Furthermore, it is believed that an advantageously sized gap G may create a localized, relatively high-pressure space between the sidewall 118 and the sealing lip 154, and such localized high pressure may create a vertically upward air flow that pushes the scaling lip 154 to a fully open position. A fully open position maximizes airflow through the valve assembly. Such configurations may advantageously enable the sealing lip 154 to translate to a fully open position with a relatively lower pressure differential between the interior 182 and exterior environment 14 compared with the breather assembly 100 with a larger gap G.

Table 1 below depicts results from testing breather assemblies constructed consistently with FIGS. 1-3 of the present disclosure. Each breather assembly is generally identical, except that the lateral gap G between the valve sealing lip (154) and the assembly sidewall (115) was varied as reflected in the table. A primary environmental opening is defined by the sidewall on the first end (102) of the sidewall. There are four “pin-hole” environmental openings defined through the sidewall (115) evenly distributed around the assembly body (110) towards a second end of the sidewall (115) that together accounted for less than 0.5% of the total area of the environmental openings. No environmental openings are defined by the assembly body between the sidewall and the second axial end of the assembly body. The gap was generally a circumferential gap surrounding the valve body (150). Testing was conducted at ambient conditions. An airflow generator was sealed to the breather assembly (100) around the assembly opening (111). The airflow generator generated airflow through the assembly opening (111) and increased the airflow at a constant rate to a maximum airflow of 2000 standard liter per minute (SLPM). The pressure differential at which the valve body (150) opened and maintained a fully open position (i.e. “flipped”) was recorded. If the valve body (150) did not flip before or upon reaching the maximum airflow, then that is noted in Table 1 as “DNF” (Did Not Flip).

TABLE 1

| | Flip Pressure (mbar) | | | | | | |
|---|---|---|---|---|---|---|---|
| Gap G (mm) | Trial 1 | Trial 2 | Trial 3 | Trial 4 | Trial 5 | Avg | Std Dev |
| 3 | 90.40 | 87.93 | 88.05 | 87.18 | 87.37 | 88.19 | 1.29 |
| 4.5 | 103.39 | 102.86 | 101.39 | 102.02 | 101.81 | 102.29 | 0.81 |
| ~6 (nominal) | 107.74 | 106.97 | 106.40 | 105.75 | 105.39 | 106.45 | 0.94 |
| 7 | DNF | DNF | DNF | DNF | DNF | DNF | DNF |
| 8 | DNF | DNF | DNF | DNF | DNF | DNF | DNF |
| 9 | DNF | DNF | DNF | DNF | DNF | DNF | DNF |

In accordance with the present data, having a gap G of greater than 6 mm between the valve body (150) and the assembly sidewall (115) resulted in a valve body (150) that did not flip open. While not wishing to be bound by theory, it is believed that having a larger gap G between the assembly sidewall (115) and the valve body (150) allows a sufficient amount of air to flow around the sealing lip (154) of the valve body and escape outward and upward without continuing to push against the valve body to open it. On the other hand, a sufficiently small gap G may prevent a sufficient amount of air from flowing around the sealing lip of the valve body (150) and thus it continues pushing the valve body towards an open position.

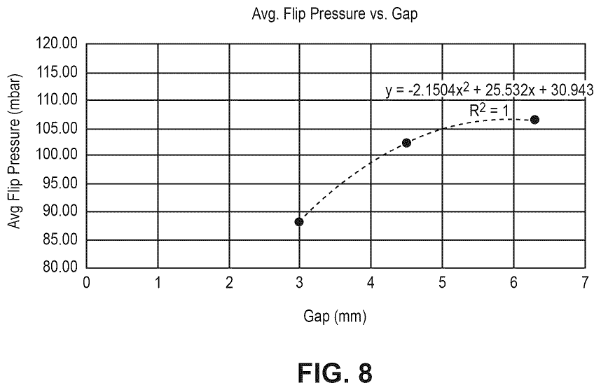

FIG. 8 plots the average flip pressure for each of the gaps tested above where the valve body did ultimately flip. Generally, the smaller the gap G, the lower the pressure differential required to flip the valve. However, as noted in the discussion above, if the gap G is too small, the assembly sidewall (115) will physically interfere with the ability of the valve body (150) to fully open and/or close. As such, the lower limit of the size of the gap G may be dependent on the physical space required by the valve body to fully open and close.

It should be appreciated that various alternative valve designs can be used with breather assemblies consistent with the technology disclosed herein.

We now return to a discussion of FIGS. 1-3. Positioning the environmental opening(s) 112 on the first end 102 of the breather assembly 100 (combined with a sufficiently small gap G as discussed above) may advantageously discourage pressure relief by the sealing lip 154 until a sufficient pressure differential has built between the second end 104 of the breather assembly 110 and the outside environment to (1) cause a maximum displacement of the sealing lip 154 and (2) maintain a fully open position of the valve body 150 for relatively rapid pressure relief. However, in some embodiments, environmental openings 112 may be desirable at other locations through the assembly body 110 for reasons including liquid drainage, as an example. In such examples, it may be desirable that the environmental openings that are not at or towards the first end 102 of the breather assembly 110 have a sufficiently small area to minimize the impact that pressure relief through those environmental openings has on the opening of the valve body.

The environmental opening(s) 112 of the breather assembly 100 can be characterized by a flow area, which is the total area of the environmental opening(s) 112 through which air flows directly to the outside environment from the airflow pathway. In various embodiments, greater than or equal to 95%, 96%, 97%, 98%, or 99% of the flow area of the environmental openings is positioned in the axial direction towards the first end of the assembly body 110. In various embodiments, greater than or equal to 95%, 96%, 97%, 98%, or 99% of the flow area of the environmental openings is positioned beyond the inner perimeter of the valve body 150 in the axial direction. In some embodiments, greater than or equal to 95%, 96%, 97%, 98%, or 99% of the flow area of the environmental openings is positioned beyond the lateral extension 128, or even beyond the distal end 172, of the valve stem 124 in the axial direction.

Preliminary testing of example breather assemblies disclosed herein found that increasing the outer diameter of the lateral extension (128) of the valve stem surprisingly lowered the pressure differential required to flip the valve body. The breather assemblies and the testing were generally consistent with the descriptions above with reference to Table 1. The breather assemblies were generally identical except that the gaps between the sidewall and the sealing lip varied, and a first set of parts had a valve stem with a lateral extension being 12.0 mm in diameter, and a second set of parts had a valve stem with a lateral extension being 27.9 mm in diameter. FIG. 14 shows the results of the testing. With a gap of 3 mm and 4.5 mm, the valve stem having a lateral extension that was 27.9 mm in diameter opened at a lower pressure than the lateral extension of the valve stem having a 12.0 mm diameter. Generally, the lateral extension has a lateral diameter that is less than the lateral diameter of the sidewall. In various embodiments, the lateral extension has a lateral diameter that is less than the lateral diameter of the sealing lip in a closed position and an open position. In various embodiments, the lateral extension has a lateral diameter that is greater than 12.0 mm, 14.0 mm, 16.0 mm or 17.0 mm. The lateral extension may have a lateral diameter that is less than 30.0 mm, 29.0 mm, or 28.0 mm.

FIG. 4. depicts a cross-sectional view of another example system generally consistent with FIG. 1 except for the differences depicted and enumerated herein. A breather assembly 400 is generally configured to be coupled to a housing 480. The breather assembly 400 has a first end 402 and a second end 404. The breather assembly 400 is generally configured to facilitate airflow between the housing 480 and an outside environment 44 when it is coupled to the housing. The breather assembly 400 has an assembly body 410. The breather assembly 400 has a coupling structure 416 configured to be coupled to the housing 180. The breather assembly 400 has a valve stem 424 coupled to the assembly body 410. The assembly body 410 has a valve body 450 coupled to the valve stem 424. The housing 480 that the breather assembly 400 is configured to be coupled to generally defines a housing opening 484 that is configured to receive the breather assembly 400. The various components can generally be consistent with descriptions of corresponding components above except where contrary to the current description.

Unlike in the previous example, here the airflow pathway 42 defined by the assembly body 410 has a vent pathway 441 that is functionally parallel with a valve pathway 451.

In the current example, the breather assembly 400 has a passive airflow vent 440 disposed in the assembly body 410. The passive airflow vent 440 allows passive airflow along the vent pathway 441 between the first end 402 and the second end 404 of the assembly body 410 under normal pressure conditions. In some embodiments the passive airflow vent 440 is configured to prevent liquids and particulates from passing therethrough. The passive airflow vent 440 can be a variety of materials and combinations of materials. Upon a high-pressure event inside the housing 480 however, as discussed above, the breather assembly 400 is configured to allow gases to escape the housing 480 by bypassing the vent pathway 441 and the passive airflow vent 440.

The passive airflow vent 440 can be constructed of a variety of different materials and combinations of materials. In some embodiments the passive airflow vent 440 is a metal foil. The passive airflow vent 440 can be an elastomeric material such as latex. In various embodiments the passive airflow vent 440 incorporates a breathable membrane. The breathable membrane is generally porous to accommodate airflow. In various examples, the breathable membrane obstructs the passage of liquid water. The breathable membrane can have a Frazier Permeability of 0.035 to 8.0 ft/min at 0.5 inches of water, and more particularly 0.035 to 3.0 ft/min at 0.5 inches of water. The breathable membrane can incorporate expanded polytetrafluorethylene (ePTFE), sintered polytetrafluorethylene (PTFE), or other types of breathable membranes.

The passive airflow vent 440 can be a laminate or composite that includes a breathable membrane. For example, the passive airflow vent 440 can be a breathable membrane laminated to a woven or non-woven support layer. In another example, the passive airflow vent 440 can be a breathable membrane having a coating. In some other embodiments, the passive airflow vent 440 can be a breathable membrane alone, without another layer. In some embodiments, the passive airflow vent 440 is a woven fabric or a non-woven fabric. The passive airflow vent 440 can be constructed of hydrophobic material, or the passive airflow vent 440 can be treated to exhibit hydrophobic properties. In one example, the passive airflow vent 440 is a hydrophobic woven or non-woven fabric.

The breather assembly 400 has a vent mounting surface 420 on which the passive airflow vent 440 is mounted. The vent mounting surface 420 is defined by the assembly body 410. The vent mounting surface 420 surrounds a vent opening 421 that defines the vent pathway 441. The passive airflow vent 440 has a perimetric region 444 bonded to the vent mounting surface 420 and an unbonded region 446 central to the perimetric region 444. In some embodiments the passive airflow vent 440 has a support ring to support the periphery of the passive airflow vent 440 that is coupled to the vent mounting surface 420.

In various embodiments, and similar to the examples discussed above with respect to FIGS. 1-3, the valve stem 424 has a lateral extension 428 towards the distal end of the valve stem. The lateral extension 428 extends laterally outward from the vent opening 421. In some such embodiments, unlike the embodiments discussed above with respect to FIGS. 1-3, the lateral extension 428 forms a vent stand 422 that defines the vent mounting surface 420. The vent mounting surface 420 is positioned radially outward from the vent opening 421. The passive airflow vent 440 can be coupled to the vent mounting surface 420 with adhesive to form a seal between the passive airflow vent 440 and the vent mounting surface 420. The passive airflow vent 440 can be coupled to the vent mounting surface 420 with an adhesive or through other approaches such as heat welding or ultrasonic welding. In some embodiments the assembly body 410 can be over-molded to the passive airflow vent 440. The passive airflow vent 440 has the perimetric region 444 coupled to the vent mounting surface 420 across the vent pathway 441. The vent pathway 441 extends axially through the vent mounting surface 420 and the valve stem 424 such that the valve stem 424 and the vent mounting surface 420 surround the vent pathway 441. The vent mounting surface 420 is defined by an outer region of the lateral extension 428. In the current example, the valve pathway 451 laterally surrounds the vent stand 422.

A recessed surface 429 is defined by the vent stand 422 centrally to the vent mounting surface 420. The recessed surface 429 is spaced from the passive airflow vent 440 in the axial direction. Such a configuration exposes the surface area of the unbonded region 446 of the passive airflow vent 440, which may advantageously increase the surface area of the passive airflow vent 440 available for airflow. In the current example, the recessed surface 429 and the passive airflow vent 440 mutually define a gap t between the unbonded region 446 of the passive airflow vent 440 and the lateral extension 428. The gap is generally sufficient to facilitate airflow from the vent opening 421 to the surface of the passive airflow vent 440.

In various implementations, the unbonded region 446 of the passive airflow vent 440 extends beyond the vent pathway 441 defined in the valve stem 424 in the lateral direction. In various implementations, the unbonded region 446 of the passive airflow vent 440 extends beyond the valve stem 424 in the lateral direction. Such a configuration may advantageously provide a relative increase in the airflow capacity through the passive airflow vent 440 by relatively increasing the available surface area of the passive airflow vent 440 compared to a vent having a relatively smaller unbonded region.

The unbonded region 446 central to the perimetric region 444. The unbonded region 446 of the passive airflow vent 440 has a surface area that is at least 5 times greater than a lateral area of the vent pathway 441 through the valve stem 424. In some embodiments, the unbonded region 446 of the passive airflow vent 440 has a surface area that is at least 20 times greater than, 100 times greater than, or 140 times greater than a lateral area of the vent pathway 441 through the valve stem 124. The size of the unbonded region 446 of the passive airflow vent 440 is generally not limited, but in some embodiments the unbonded region 446 has a surface area that is at least 100 mm², at least 200 mm², at least 300 mm², at least 400 mm², or at least 500 mm². The unbonded region 446 of the passive airflow vent 440 may have a surface area that is no more than 2000 mm², no more than 1000 mm², or no more than 800 mm². In some specific embodiments the unbonded region 446 of the passive airflow vent 440 has a surface area of 490 mm².

In the current example, the passive airflow vent 440 forms a circular disk, although the passive airflow vent 440 can have other shapes as well.

In the current embodiments, the valve body 450 is coupled to the vent stand 422. The valve body 450 extends radially outward from the valve stem 424. The valve body 450 is compressibly received between the assembly body 410 and the lateral extension 428. In particular, the valve body 450 has an inner perimeter defining a valve opening 452, and the valve body 450 extends from the inner perimeter to a scaling lip 454 defined by the outer perimeter. In the current example, the inner perimeter is coupled to the valve stem 424 such that the valve stem 424 is disposed in the valve opening 452. The sealing lip 454 of the valve body 450 is translatable between a closed position towards a proximal end 470 of the valve stem 424 and an open position away from the proximal end 470 and beyond a distal end 472 of the valve stem 424. In such embodiments, the valve body 450 is configured to abut the outer perimeter of the lateral extension 428 in the open position.

Furthermore, it should be appreciated that the specific vent design is not particularly limited, and various alternative vent designs can be used with breather assemblies consistent with the technology disclosed herein.

It has been discovered that minimizing the airflow area of the environmental opening(s) between the second end 404 of the breather assembly 400 and the inner perimeter 453 of the valve body 450 can impact whether the valve body 450 flips to a completely open state. For example, data suggests the axial length h of the sidewall 415 surrounding the valve body 450 can impact whether the valve body 450 flips to a completely open state. Additionally, the axial length h of the sidewall can additionally impact the extent of the axial translation of the sealing lip from the valve sealing surface 113 to its open position. The axial length of the sidewall refers to the axial extension of the sidewall from the valve sealing surface 413 to the first axial end 402 of the breather assembly 400.

Testing was conducted with breather assemblies having a 3 mm gap G between the valve body 450 and the sidewall 415. The breather assemblies were generally identical except that the axial length h of the assembly sidewall (115) was varied, where an axial length of 3 mm, 6 mm, 9 mm, 12 mm and 14.6 mm were tested. The axial length of each of the valve bodies was 8.9 mm (in a closed position), and the axial length from the sealing surface to the distal end of the valve stem was 11.5 mm. The sidewall 415 of each breather assembly (400) defined an axially-facing environmental opening on the first end (402) of the breather assembly and four laterally-facing pin-hole environmental openings evenly distributed around the central axis of the assembly body (410) towards the second end of the sidewall, where the pin-hole environmental openings totaled less than 0.5% of the total flow area of the environmental openings. The assembly body (410) lacked environmental openings between the sidewall and the second end (404) of the breather assembly (400). None of the breather assemblies had a vent opening (421).

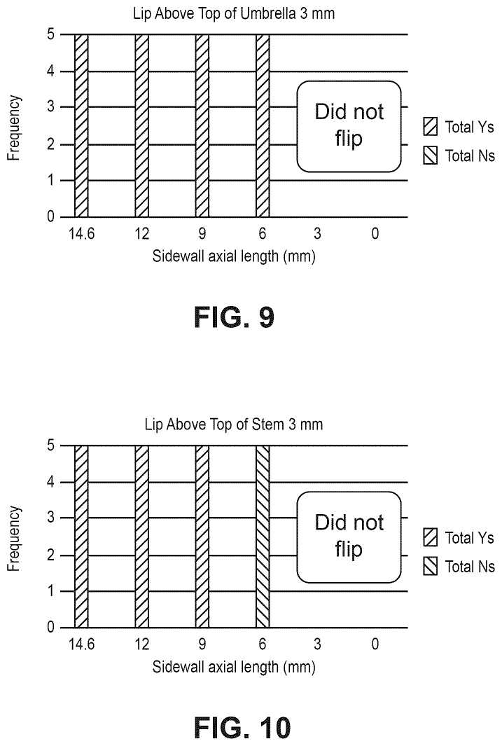

Testing was conducted at ambient conditions. An airflow generator was sealed to the breather assembly (400) around the assembly opening (411). The airflow generator generated airflow through the assembly opening (411) and gradually increased airflow at a constant rate up to a maximum airflow of 2000 standard liter per minute (SLPM). If the valve body (450) did not flip before or upon reaching the maximum airflow, then that data was noted. If the valve body flipped, then whether the sealing lip translated to a position past the distal end of the valve body upon flipping was noted, which is reflected in FIG. 9, and whether the sealing lip translated past the distal end of the valve stem upon flipping was also noted, which is reflected in FIG. 10.

As reflected in FIGS. 9 and 10, when the sidewall had an axial length h of 6 mm and above the valve bodies reliably flipped. At an axial length h of 6 mm, the sealing lip did reliably translate to a position beyond the distal end of the valve body, but did not translate to a position beyond the distal end of the valve stem. On the other hand, for the axial lengths tested that were greater than 6 mm, the sealing lip of the valve body did reliably translate beyond the distal end of the valve body and the distal end of the valve stem upon flipping.

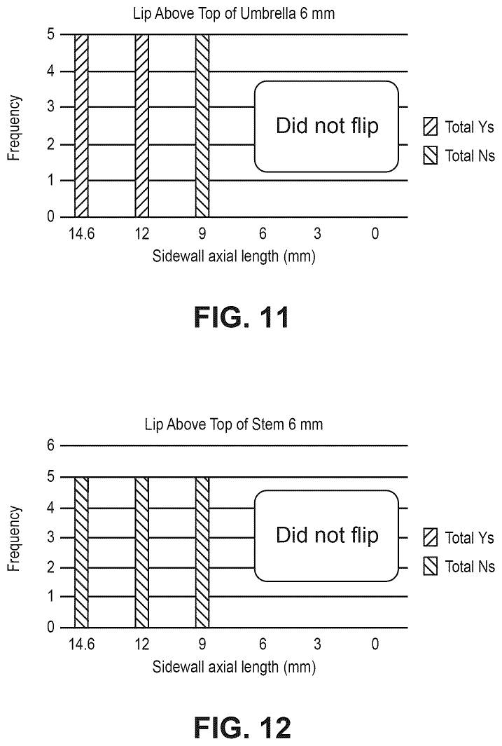

FIGS. 11 and 12 reflect data collected with additional testing of breather assemblies consistent with those described above with reference to FIGS. 9-10, except these assemblies had a lateral gap G of 6 mm between the valve sealing lip and the sidewalls, and the sidewalls had the same axial sidewall lengths discussed above with reference to FIGS. 9 and 10. Notably, at any axial length h of sidewall tested, no sealing lip of a valve body translated to a position beyond the distal end of the valve stem, and no valve body flipped at an axial sidewall length h of 6 mm or 3 mm. At a 14.6 mm axial sidewall length h and a 12 mm axial sidewall length h, the sealing lip did translate beyond the distal end of the valve body 450 but did not when the axial length h was 9 mm.

It may be desirable to design a breather assembly that maximizes airflow through the relief valve by ensuring translation of the sealing lip beyond at least the distal end of the valve body when in a fully open (flipped) position.

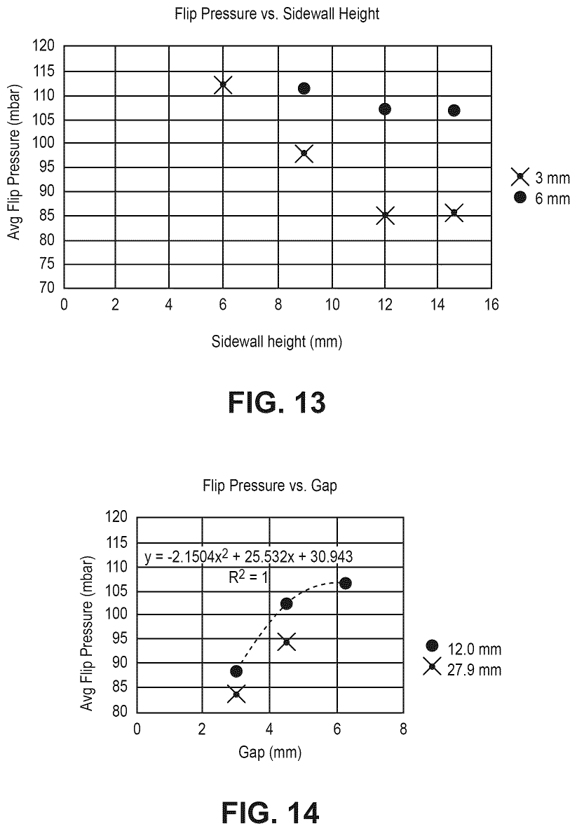

Interestingly, data resulting from this testing suggests that the axial length of the sidewall may have a maximum impact on the flip pressure of the valve body. FIG. 13 depicts the recorded flip pressure for each of the breather assemblies described and tested with reference to FIGS. 9-12. A reduction in flip pressure appears to occur up to an axial sidewall length of 12 mm for both the breather assembly having a 3 mm gap G and the breather assembly having a 6 mm gap. At an axial sidewall length of 14 mm, the flip pressure is within 1% of the flip pressure at an axial sidewall length of 12 mm and is therefore considered approximately constant. However, at an axial sidewall length h of 12 mm and below, there appears to be a separate linear relationship between the sidewall length h and the flip pressure, depending on the gap G.

In some embodiments, the axial sidewall extends from the valve sealing surface beyond the axial position of the sealing lip when the valve body is in a fully open position. In some embodiments, it may be desirable to have an axial sidewall that extends from the valve sealing surface to at least the distal end of the valve body. In some embodiments, it may be desirable to have an axial sidewall that extends from the valve sealing surface beyond the distal end of the valve body. In some embodiments, it may be desirable to have an axial sidewall that extends from the valve sealing surface to at least the lateral extension of the valve stem or even beyond the lateral extension of the valve stem. It will be appreciated based on the data discussed above, however, that the reductions in flip pressure do not continue indefinitely as the length of the axial sidewall increases, and thus the maximum sidewall length may be based on design constraints of the system within which the breather assembly will be used. In some embodiments, it may be desirable to have a sidewall with an axial length that far exceeds the axial sidewall lengths that reduce flip pressure, such as in designs where the sidewall is used as a conduit to direct airflow to a particular location within a system, or as another example, where the sidewall is configured to couple to other components within the system.

Preliminary testing of breather assemblies consistent with FIG. 4 show that there is about a 6.64% increase in pressure differential required to flip the valve body 450 in a first example part where a passive airflow vent (440) is omitted (and the vent pathway is open) compared to a second example part with an identical valve body 450 where the vent pathway (441) is sealed. It is expected that the increase in pressure differential required to flip the valve body will be reduced in a valve assembly where the vent pathway remains open and a passive airflow vent (440) is coupled to the vent mounting surface (420) compared to the first example part, depending on the airflow accommodated by the passive airflow vent.

FIG. 5. depicts cross-sectional view of another example assembly consistent with the present technology. The breather assembly 500 is generally configured to be coupled to the housing. The breather assembly 500 has a first end 502 and a second end 504. The breather assembly 500 is generally configured to facilitate airflow between the housing and an outside environment 54 when it is coupled to the housing. The breather assembly 500 has an assembly body 510. The breather assembly 500 has the coupling structure 516 configured to be coupled to the housing. The breather assembly 500 has a valve stem 524 defining a vent stand 522 coupled to the assembly body 510. The assembly body 510 has a passive airflow vent 540 coupled to the vent stand 522. The assembly body 510 has a valve body 550 coupled to the vent stand 522. The housing that the breather assembly 500 is configured to be coupled to generally defines a housing opening that is configured to receive the breather assembly 500. Components herein are generally consistent with descriptions of corresponding components in the examples discussed above except where contrary to the current description or figure.

The assembly body 510 generally has features already described herein. In the current example, the assembly body 510 has an end face 514 extending laterally across a first end of an assembly sidewall 515. In the current example, the assembly body 510 has a base portion 517 and a cover 508, where the cover has a different configuration than the examples shown in FIGS. 1-4. In the current example, the cover defines a portion of the assembly sidewall 515 and also extends laterally across an airflow pathway 52. The assembly sidewall 515, the base portion 517, and the end face 514 house the breather components. The assembly sidewall 515 extends axially between the base portion 517 and the end face 514. In the current example, the assembly sidewall 515 and the end face 514 are integrated in a single component that is coupled to the base, but in other embodiments, the assembly sidewall and the end face can be separate components.

In the current example, the cover 508 has an environmental opening 512. In particular, the environmental opening 512 include laterally facing openings 512b and axially facing openings 512a. The assembly body 510 defines a first set of flow channels 560 extending inward from the laterally facing openings 512b and a second set of flow channels 562 extending outward from the axially facing openings 512a. The first set of flow channels 560 are oriented towards the second set of flow channels 562. In the current example, the first set of flow channels 560 is configured to have fluid flow communication with the second set of flow channels 562. Such configurations may advantageously redirect containments and/or prevent containments from entering into the assembly body 510, for example, liquids from the outside environment 54.

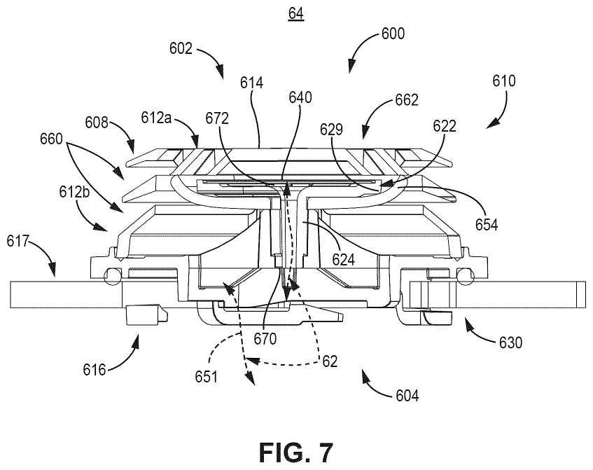

FIG. 6 depicts an exploded view of another example assembly consistent with the present technology, and FIG. 7 is a cross-sectional view of the example of FIG. 6, where the valve sealing lip is in a fully open position. Components herein are generally consistent with descriptions of corresponding components in the examples discussed above except where contrary to the current description or figure. A breather assembly 600 is generally configured to be coupled to a housing. The breather assembly 600 has a first end 602 and a second end 604. The breather assembly 600 is generally configured to facilitate airflow between the housing and an outside environment 64 when it is coupled to the housing. The breather assembly 600 has an assembly body 610. The breather assembly 600 has a coupling structure 616 configured to be coupled to the housing. The breather assembly 600 has a valve stem 624 defining a vent stand 622 coupled to the assembly body 610. The assembly body 610 has a passive airflow vent 640 coupled to the vent stand 622. The assembly body 610 has a valve body 650 coupled to the vent stand 622. The housing that the breather assembly 600 is configured to be coupled to generally defines a housing opening that is configured to receive the breather assembly 600.

The airflow pathway 62 has a valve pathway 651. The valve stem 624 is coupled to the assembly body 610. The valve stem 624 extends axially from a proximal end 670 to a distal end 672. The valve pathway laterally surrounds the valve stem 624. The valve body 650 is disposed across the valve pathway 651 having an inner perimeter defining a valve opening and an outer perimeter defining a scaling lip 654 forming a releasable seal with the assembly body 610. The inner perimeter is coupled to the valve stem 624. The sealing lip 654 is translatable between a closed position towards the proximal end 670 of the valve stem and a fully open position away from the proximal end 670 and beyond the distal end 672 of the valve stem 624. As is particularly visible in FIG. 7, the valve body is configured to abut an outer perimeter of the lateral extension 629 in the fully open position.

Unlike the previous example, in the current example, the coupling structure 616 is a bayonet connector. The bayonet connector is defined by the assembly body 610. The mating structure is a bayonet receptacle that is configured to be received by the bayonet connector. The coupling structure 616 can be consistent with the coupling structure described in detail above.

The assembly body 610 has a base portion 617 and a cover 608. The cover 608 generally extends axially around the airflow pathway 62. In the current example, the cover 608 has an environmental opening 612. The environmental opening 612 has laterally facing openings 612b and axially facing openings 612a. The assembly body 610 defines a first set of flow channels 660 extending inward from the laterally facing openings 612b and a second set of flow channels 662 extending outward from the axially facing openings 612a. The assembly body 610 has an end face 614 extending laterally across a first end of an assembly sidewall 615. The base portion 617 and the cover 608 can be consistent with the technology disclosed herein.

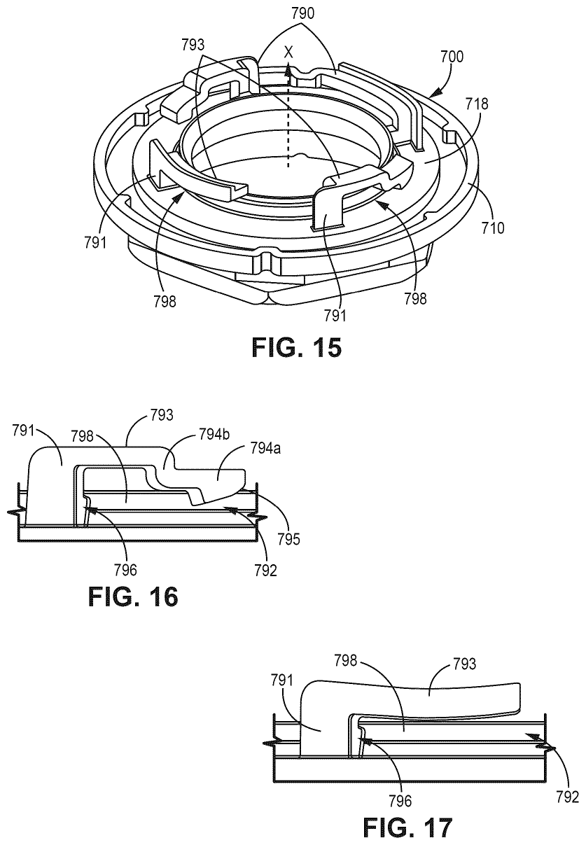

As has been discussed, the coupling structure of disclosed breather assemblies consistent with the technology disclosed herein can have a variety of different configurations and combinations of configurations. FIGS. 15-17 depict one example coupling structure that is a bayonet connector, which will now be described. FIG. 15 is a perspective view of the bayonet connector, FIG. 16 is a detail facing view of a first bayonet leg, and FIG. 17 is a detail facing view of a second bayonet leg. Such a bayonet connector can be used with any type of assembly, including a breather assembly, that is configured to engage a bayonet receptacle define by another component.

In the current example, the bayonet connector 716 is defined by the assembly body 710. While the bayonet connector can have a variety of different configurations, in the current configuration the bayonet connector has a plurality of legs 790 that extend axially outward and partially circumferentially around a central axis x of the breather assembly 700. In particular, each of the plurality of legs 790 has an axial extension 791 extending axially outward from a surface 718 of the assembly body 710, and a partial circumferential extension 793 extending partially circumferentially around the central axis x of the breather assembly 700. As such, each leg 790 defines a partial circumferential channel 798 between the surface 718 of the assembly body 710 and the partial circumferential extension 793. Each circumferential channel 798 similarly extends partially circumferentially around the central axis x of the breather assembly 700.

Each partial circumferential channel 798 has an open end 792 and a closed end 176. In various implementations, each partial circumferential channel 798 is configured to receive a mating bayonet connecting feature, such as a radial tab (not visible) extending inwardly relative to bayonet opening.

In the current example, the bayonet legs 790 have two different configurations. A first bayonet leg 790, shown in FIG. 16, has an axially extending first retaining ridge 794a separating the open end 792 and the closed end 796. The first retaining ridge 794a is defined by the partial circumferential extension 793 of the leg 790. The first bayonet let 790 also defines a second retaining ridge 794b that is also axially extending. The first retaining ridge 794a and the second retaining ridge 794b have a stepped configuration towards the surface 718 of the assembly body such that that circumferential channel 798 narrows from the closed end 796 to the open end 792. In particular, the partial circumferential extension 793 extends laterally from the axial extension, and at the second retaining ridge 794b the partial circumferential extension 793 extends axially towards the surface 718 and then laterally again toward the open end 792. At the first retaining ridge 794a the partial circumferential extension 793 extends axially towards the surface 718, which further narrows the partial circumferential channel 798. The partial circumferential extension 793 defines a ramped surface 795 that extends axially away from the surface 718 such that the partial circumferential channel 798 widens towards the open end 792.

In a second bayonet leg 790, shown in FIG. 17, the partial circumferential extension bows towards the surface 718 between the open end 792 and the closed end 796. As a result, the central portion of the circumferential channel 798 narrows between the open end 792 and the closed end 796. Such a configuration may advantageously exert a compression force when installed on another component, which may facilitate formation of a seal.

In the current example, the first bayonet leg and the second bayonet leg alternate circumferentially around the assembly body 710.

### Exemplary Aspects

Aspect 1. A breather assembly comprising: a coupling structure configured to be coupled to a housing; an assembly body defining an assembly opening, environmental openings, and an airflow pathway between the assembly opening and an outside environment through the environmental openings, wherein the airflow pathway comprises a valve pathway; a valve stem coupled to the assembly body, extending axially from a proximal end to a distal end, wherein the valve pathway laterally surrounds the valve stem; and a valve body disposed across the valve pathway having an inner perimeter defining a valve opening and an outer perimeter defining a sealing lip forming a releasable seal with the assembly body, wherein the inner perimeter is coupled to the valve stem, and the sealing lip is translatable between a closed position towards the proximal end of the valve stem and a fully open position away from the proximal end and beyond the distal end of the valve stem.

Aspect 2. The breather assembly of any one of aspects 1 and 3-14, wherein the inner perimeter is coupled to the valve stem towards the distal end of the valve stem.

Aspect 3. The breather assembly of any one of aspects 1-2 and 4-14, wherein the assembly body comprises a sidewall laterally surrounding the valve body.

Aspect 4. The breather assembly of any one of aspects 1-3 and 5-14, wherein the sidewall is within 4 mm of the valve sealing lip.

Aspect 5. The breather assembly of any one of aspects 1-4 and 6-14, further comprising an end wall extending laterally across the airflow pathway.

Aspect 6. The breather assembly of any one of aspects 1-5 and 7-14, wherein the valve stem comprises a lateral extension on the distal end that extends laterally outward from the valve stem.

Aspect 7. The breather assembly of any one of aspects 1-6 and 8-14, wherein the valve body is configured to abut the outer perimeter of the lateral extension in the fully open position.

Aspect 8. The breather assembly of any one of aspects 1-7 and 9-14, wherein the valve body is compressibly received between the assembly body and the lateral extension.

Aspect 9. The breather assembly of any one of aspects 1-8 and 10-14, further comprising: a vent pathway that is functionally parallel with the valve pathway along the airflow pathway, wherein the lateral extension defines a vent mounting surface and the vent pathway extends axially through the vent mounting surface and the valve stem; and a passive airflow vent having a perimetric region coupled to the vent mounting surface across the vent pathway, and an unbonded region central to the perimetric region.

Aspect 10. The breather assembly of any one of aspects 1-9 and 11-14, wherein the lateral extension defines a recessed surface centrally to the vent mounting surface to define a gap between the unbonded region of the passive airflow vent and the lateral extension.

Aspect 11. The breather assembly of any one of aspects 1-10 and 12-14, wherein the unbonded region of the passive airflow vent has a surface area that is at least 5 times greater than a lateral area of the vent pathway through the valve stem.

Aspect 12. The breather assembly of any one of aspects 1-11 and 13-14, wherein the assembly body comprises a base portion and a cover, wherein the cover extends laterally across the airflow pathway.

Aspect 13. The breather assembly of any one of aspects 1-12 and 14-14, wherein the valve stem is compressibly received by the valve body.

Aspect 14. The breather assembly of any one of aspects 1-13, wherein the valve stem is integral with the assembly body.

Aspect 15. A breather assembly comprising: a coupling structure configured to be coupled to a housing; an assembly body defining an assembly opening, environmental openings, and an airflow pathway between the assembly opening and an outside environment through the environmental openings, wherein the airflow pathway comprises a vent pathway and a valve pathway functionally parallel with the vent pathway along the airflow pathway; a vent stand coupled to the assembly body, wherein the vent stand comprises a lateral extension defining a vent mounting surface and a valve stem extending axially outward from the lateral extension, wherein the vent pathway extends axially through the vent mounting surface and the valve stem, the vent mounting surface extends laterally outward from the valve stem, and the valve pathway surrounds the vent stand; a passive airflow vent having a perimetric region coupled to the vent mounting surface across the vent pathway, and an unbonded region central to the perimetric region; and a valve body disposed across the valve pathway having inner perimeter defining a valve opening and an outer perimeter defining a sealing lip, wherein the valve stem is disposed in the valve opening, and wherein the sealing lip is laterally outwards from the vent mounting surface.

Aspect 16. The breather assembly of any one of aspects 15 and 17-29, wherein the lateral extension defines a recessed surface centrally to the vent mounting surface to define a gap between the unbonded region of the passive airflow vent and the lateral extension.

Aspect 17. The breather assembly of any one of aspects 15-16 and 18-29, wherein the unbonded region of the passive airflow vent has a surface area that is at least 5 times greater than a lateral area of the vent pathway through the valve stem.

Aspect 18. The breather assembly of any one of aspects 15-17 and 19-29, wherein the assembly body comprises a base portion and a cover, wherein the cover extends laterally across the airflow pathway.

Aspect 19. The breather assembly of any one of aspects 15-18 and 20-29, wherein the valve body is compressibly received between the assembly body and the lateral extension.

Aspect 20. The breather assembly of any one of aspects 15-19 and 21-29, wherein the valve stem is compressibly received by the valve body.

Aspect 21. The breather assembly of any one of aspects 15-20 and 22-29, wherein the valve stem is integral with the assembly body.

Aspect 22. The breather assembly of any one of aspects 15-21 and 23-29, wherein the assembly body comprises a sidewall laterally surrounding the valve body.

Aspect 23. The breather assembly of any one of aspects 15-22 and 24-29, wherein there is a lateral gap between the sidewall and the valve sealing lip of 3 mm or more.

Aspect 24. The breather assembly of any one of aspects 15-23 and 25-29, wherein there is a lateral gap between the sidewall and the valve sealing lip of less than 6 mm.

Aspect 25. The breather assembly of any one of aspects 15-24 and 26-29, wherein there is a lateral gap between the sidewall and the valve sealing lip of less than 4 mm.

Aspect 26. The breather assembly of any one of aspects 15-25 and 27-29, wherein the sidewall has an axial length that is greater than an axial length of the valve body.

Aspect 27. The breather assembly of any one of aspects 15-26 and 28-29, wherein the sidewall has an axial length that is greater than an axial length from a valve sealing surface of the valve body to the distal end of the valve stem.

Aspect 28. The breather assembly of any one of aspects 15-27 and 29 wherein the environmental openings define a flow area, and greater than 96% of the flow area of the environmental openings is positioned in the axial direction towards the first end of the assembly body, beyond the inner perimeter of the valve body.

Aspect 29. The breather assembly of any one of aspects 15-28, wherein the valve body has a fully open position where the sealing lip defines a distal end of the valve body.

Aspect 30. A breather assembly comprising: a coupling structure configured to be coupled to a housing; an assembly body having a first end and a second end and defining an assembly opening, environmental openings, and an airflow pathway between the assembly opening and an outside environment through the environmental openings, wherein the airflow pathway comprises a valve pathway; a valve stem coupled to the assembly body, extending axially from a proximal end to a distal end, wherein the valve pathway laterally surrounds the valve stem; and a valve body disposed across the valve pathway having an inner perimeter defining a valve opening and an outer perimeter defining a sealing lip forming a releasable seal with the assembly body, wherein the inner perimeter is coupled to the valve stem, and the sealing lip is translatable between a closed position towards the proximal end of the valve stem where the sealing lip defines a proximal end of the valve body and a fully open position towards the distal end of the valve stem, and wherein the environmental openings define a flow area, and greater than 96% of the flow area of the environmental openings is positioned in the axial direction towards the first end of the assembly body, beyond the inner perimeter of the valve body.

Aspect 31. The breather assembly of any one of aspects 30 and 32-50, wherein, in a fully open position, the sealing lip defines a distal end of the valve body.

Aspect 32. The breather assembly of any one of aspects 30-31 and 33-50, wherein the inner perimeter is coupled to the valve stem towards the distal end of the valve stem.

Aspect 33. The breather assembly of any one of aspects 30-32 and 34-50, wherein the assembly body comprises a sidewall laterally surrounding the valve body.

Aspect 34. The breather assembly of any one of aspects 30-33 and 35-50, wherein there is a lateral gap between the sidewall and the valve sealing lip of 30 mm or more.

Aspect 35. The breather assembly of any one of aspects 30-34 and 36-50, wherein there is a lateral gap between the sidewall and the valve sealing lip of 3 mm or more.

Aspect 36. The breather assembly of any one of aspects 30-35 and 37-50, wherein there is a lateral gap between the sidewall and the valve sealing lip of less than 6 mm.

Aspect 37. The breather assembly of any one of aspects 30-36 and 38-50, wherein there is a lateral gap between the sidewall and the valve sealing lip of less than 4 mm.

Aspect 38. The breather assembly of any one of aspects 30-37 and 39-50, wherein the sidewall has an axial length that is greater than an axial length of the valve body.

Aspect 39. The breather assembly of any one of aspects 30-38 and 40-50, wherein the sidewall has an axial length that is greater than an axial length from a valve sealing surface of the valve body to the distal end of the valve stem.

Aspect 40. The breather assembly of any one of aspects 30-39 and 41-50, further comprising an end wall extending laterally across the airflow pathway.

Aspect 41. The breather assembly of any one of aspects 30-40 and 42-50, wherein the valve stem comprises a lateral extension on the distal end that extends laterally outward from the valve stem.

Aspect 42. The breather assembly of any one of aspects 30-41 and 43-50, wherein the valve body is configured to abut the outer perimeter of the lateral extension in the fully open position.

Aspect 43. The breather assembly of any one of aspects 30-42 and 44-50, wherein the valve body is compressibly received between the assembly body and the lateral extension.

Aspect 44. The breather assembly of any one of aspects 30-43 and 45-50, further comprising: a vent pathway that is functionally parallel with the valve pathway along the airflow pathway, wherein the lateral extension defines a vent mounting surface and the vent pathway extends axially through the vent mounting surface and the valve stem; and a passive airflow vent having a perimetric region coupled to the vent mounting surface across the vent pathway, and an unbonded region central to the perimetric region.

Aspect 45. The breather assembly of any one of aspects 30-44 and 46-50, wherein the lateral extension defines a recessed surface centrally to the vent mounting surface to define a gap between the unbonded region of the passive airflow vent and the lateral extension.

Aspect 46. The breather assembly of any one of aspects 30-45 and 47-50, wherein the unbonded region of the passive airflow vent has a surface area that is at least 5 times greater than a lateral area of the vent pathway through the valve stem.

Aspect 47. The breather assembly of any one of aspects 30-46 and 48-50, wherein the assembly body comprises a base portion and a cover, wherein the cover extends laterally across the airflow pathway.

Aspect 48. The breather assembly of any one of aspects 30-47 and 49-50, wherein the valve stem is compressibly received by the valve body.

Aspect 49. The breather assembly of any one of aspects 30-48 and 50, wherein the valve stem is integral with the assembly body.

Aspect 50. The breather assembly of any one of aspects 30-49, wherein in the fully open position the sealing lip is beyond the distal end of the valve stem.

It should also be noted that, as used in this specification and the appended claims, the phrase “configured” describes a system, apparatus, or other structure that is constructed to perform a particular task or adopt a particular configuration. The word “configured” can be used interchangeably with similar words such as “arranged”, “constructed”, “manufactured”, and the like.

The term “about” as used herein can allow for a degree of variability in a value or range, for example, within 10%, within 5%, or within 1% of a stated value or of a stated limit of a range and includes the exact stated value or range. The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

All publications and patent applications in this specification are indicative of the level of ordinary skill in the art to which this technology pertains. All publications and patent applications are herein incorporated by reference to the same extent as if each individual publication or patent application was specifically and individually indicated by reference. In the event that any inconsistency exists between the disclosure of the present application and the disclosure(s) of any document incorporated herein by reference, the disclosure of the present application shall govern.

This application is intended to cover adaptations or variations of the present subject matter. It is to be understood that the above description is intended to be illustrative, and not restrictive, and the claims are not limited to the illustrative embodiments as set forth herein.

What is claimed is:

1. A breather assembly comprising:
a coupling structure configured to be coupled to a housing;
an assembly body having a first end and a second end and defining an assembly opening, environmental openings, and an airflow pathway between the assembly opening and an outside environment through the environmental openings, wherein the airflow pathway comprises a valve pathway;
a valve stem coupled to the assembly body, extending axially from a proximal end to a distal end, wherein the valve pathway laterally surrounds the valve stem; and
a valve body disposed across the valve pathway having an inner perimeter defining a valve opening and an outer perimeter defining a sealing lip forming a releasable seal with the assembly body, wherein the inner perimeter is coupled to the valve stem, and the sealing lip is translatable between a closed position towards the proximal end of the valve stem where the sealing lip defines a proximal end of the valve body and a fully open position towards the distal end of the valve stem, and wherein the environmental openings define a flow area, and greater than 96% of the flow area of the environmental openings is positioned in the axial direction towards the first end of the assembly body, beyond the inner perimeter of the valve body.

2. The breather assembly of claim 1, wherein, in a fully open position, the sealing lip defines a distal end of the valve body.

3. The breather assembly of claim 1, wherein the inner perimeter is coupled to the valve stem towards the distal end of the valve stem.

4. The breather assembly of claim 1, wherein the assembly body comprises a sidewall laterally surrounding the valve body.

5. The breather assembly of claim 4, wherein there is a lateral gap between the sidewall and the valve sealing lip of 1 mm or more.

6. The breather assembly of claim 4, wherein there is a lateral gap between the sidewall and the valve sealing lip of less than 6 mm.

7. The breather assembly of claim 4, wherein the sidewall has an axial length that is greater than an axial length from a sealing surface of the valve body to the distal end of the valve stem.

8. The breather assembly of claim 1, further comprising an end wall extending laterally across the airflow pathway.

9. The breather assembly of claim 1, wherein the valve stem comprises a lateral extension on the distal end that extends laterally outward from the valve stem.

10. The breather assembly of claim 9, wherein the valve body is configured to abut the outer perimeter of the lateral extension in the fully open position.

11. The breather assembly of claim 9, further comprising: a vent pathway that is functionally parallel with the valve pathway along the airflow pathway, wherein the lateral extension defines a vent mounting surface and the vent pathway extends axially through the vent mounting surface and the valve stem; and
a passive airflow vent having a perimetric region coupled to the vent mounting surface across the vent pathway, and an unbonded region central to the perimetric region.

12. The breather assembly of claim 1, wherein the valve stem is compressibly received by the valve body.

13. A breather assembly comprising:
a coupling structure configured to be coupled to a housing;
an assembly body defining an assembly opening, environmental openings, and an airflow pathway between the assembly opening and an outside environment through the environmental openings, wherein the airflow pathway comprises a vent pathway and a valve pathway functionally parallel with the vent pathway along the airflow pathway;
a vent stand coupled to the assembly body, wherein the vent stand comprises a lateral extension defining a vent mounting surface and a valve stem extending axially outward from the lateral extension, wherein the vent pathway extends axially through the vent mounting surface and the valve stem, the vent mounting surface extends laterally outward from the valve stem, and the valve pathway surrounds the vent stand;
a passive airflow vent having a perimetric region coupled to the vent mounting surface across the vent pathway, and an unbonded region central to the perimetric region; and
a valve body disposed across the valve pathway having inner perimeter defining a valve opening and an outer perimeter defining a sealing lip, wherein the valve stem is disposed in the valve opening, and wherein the sealing lip is laterally outwards from the vent mounting surface.

14. The breather assembly of claim 13, wherein the lateral extension defines a recessed surface centrally to the vent mounting surface to define a gap between the unbonded region of the passive airflow vent and the lateral extension.

15. The breather assembly of claim 13, wherein the unbonded region of the passive airflow vent has a surface area that is at least 5 times greater than a lateral area of the vent pathway through the valve stem.

16. The breather assembly of claim 13, wherein the valve stem is compressibly received by the valve body.

17. The breather assembly of claim 13, wherein the assembly body comprises a sidewall laterally surrounding the valve body.

18. The breather assembly of claim 17, wherein there is a lateral gap between the sidewall and the valve sealing lip of 3 mm or more.

19. The breather assembly of claim 17, wherein there is a lateral gap between the sidewall and the valve sealing lip of less than 6 mm.

20. The breather assembly of claim 17, wherein the sidewall has an axial length that is greater than an axial length from a valve sealing surface of the valve body to a distal end of the valve stem.
